(19) United States
(12) Patent Application Publication
(10) Pub. No.: US 2015/0221140 A1
(43) Pub. Date: Aug. 6, 2015

(54) PARKING AND TOLLGATE PAYMENT PROCESSING BASED ON VEHICLE REMOTE IDENTIFICATION

(71) Applicant: Gilbert Eid, Kahhaleh (LB)

(72) Inventor: Gilbert Eid, Kahhaleh (LB)

(21) Appl. No.: 14/258,584

(22) Filed: Apr. 22, 2014

Related U.S. Application Data
(63) Continuation-in-part of application No. 14/172,025, filed on Feb. 4, 2014.

(51) Int. Cl. G07B 15/06; G06Q 40/00

(52) U.S. Cl. CPC G07B 15/063; G06Q 40/12

(57) ABSTRACT

Methods and systems for processing tollgate and parking payments are provided. This technology requires installation of identification tags, such as RFID tags, on vehicles, which actively or passively emit identification signals conveying vehicle identifiers. Government officials, parking meters, and tollgates can be equipped with a dedicated electronic device having an emitter for acquiring identification signals and identifying vehicles based thereupon. Once the vehicle is identified, the electronic device can make a charge transaction in accordance with one or more predetermined rules and against a vehicle owner's account maintained by a database of registered vehicles. Accordingly, the charge transaction provides the automatic payment for parking, the use of toll roads, or fee associated with traffic or parking violation.

### CROSS-REFERENCE TO RELATED APPLICATIONS

This application is Continuation-in-Part of U.S. Utility patent application Ser. No. 14/172,025, filed on Feb. 4, 2014, entitled “Remote Identification of Vehicle Status,” which is incorporated herein by reference in its entirety for all purposes.

### TECHNICAL FIELD

This disclosure relates generally to vehicle identification and, more specifically, to the wireless technology for identifying vehicles, and processing payments related to parking, the use of toll roads, and fines for traffic or parking violations.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

As it well known, license plates are used for identification of vehicles all over the world. Each license plate has an unique number which is typically associated with the owner of a particular vehicle. Unfortunately, the use of traditional license plates for vehicle identification is vulnerable to a number of threads.

First, if a vehicle is stolen, criminals can easily remove license plates or replace them with fraudulent ones. In this case, identifying vehicle is problematic. Second, there are video systems, which are configured to automatically scan license plates from captured video images and determine if a particular vehicle is involved in a parking or traffic violation. These video systems may not always properly identify vehicles, especially when license plates are removed or obscured with foreign matter. In all of these and similar circumstances, there can be difficulties in the manual or automatic identifying of vehicles. Accordingly, it can be problematic to charge payments or fines related to parking, traffic violations, and/or the use of toll roads.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Various embodiments of the present disclosure provide methods and systems for effective vehicle identification, which can be utilized in finding stolen, wanted, or suspicious motor vehicles, in addition to facilitating processing of payments associated with parking, fines for parking or traffic violations, or the use of toll roads. Importantly, the methods and systems disclosed herein can be utilized not only by general public, for example, in the form of “crowdsourcing,” but also by authorities such as government officials or police officers. Notably, the present technology allows locating and identifying vehicles while respecting privacy laws and complying with constitutional rights of the citizens.

Specifically, the present technology involves installation of wireless passive or active identification tags, such as, but not limited to, RFID tags, Wi-Fi tags, Bluetooth tags, and so forth, on all or certain motor vehicles within a dedicated area such as a country, state, district, or private land or parcel. The identification tag can be configured to emit identification signals, which include a vehicle identifier and, optionally, other information. The identification signal can be propagated across a relatively short distance, for example, less than 300 feet or even less than 100 feet when the vehicle is in an unassisted view of a human eye. The present technology may also employ the use of an electronic device, such as a portable computer, tablet computer, or wireless telephone, which includes a special reader or antenna configured to wirelessly communicate with the identification tags installed on vehicles. For these ends, the electronic device may run a dedicated software application (e.g., mobile application) to implement the methods described herein for communication with the identification tags and remote databases to identify a status of a particular motor vehicle, make reports, issue tickets for traffic or parking violations, process payments, and so forth. In particular, upon receipt of the identification signals from a vehicle in proximity of the electronic device, the software application can identify a vehicle and related information, and then make a determinative decision for its user as to whether a particular motor vehicle is stolen, wanted, or needs to be monitored in view of specific circumstances. Furthermore, the software application can make a determinative decision as to whether or not a particular identified vehicle is currently moving or parked. The determination of vehicle status can be made by sending requests to one or more remote servers maintaining a database of vehicle statuses and by analyzing the server's response. Notably, the remote server(s) may also maintain a database with vehicle registration and/or vehicle related information. Moreover, the remote server(s) may also maintain or be operatively connected to government databases of the same or similar content. The server(s), upon receiving a request from the electronic device, can return vehicle status information (e.g., ‘stolen,’ ‘wanted,’ etc.) and, optionally, other vehicle-related information including, for example, vehicle registration information, list of prior offences, incidents, accidents, owner's name, plate number, date of state inspection, vehicle's color, vehicle's year, vehicle identification number, and so forth. The vehicle status may be displayed to the user of the electronic device to prompt the user to take certain actions. The actions may include, without limitation, reporting the location of the stolen vehicle to authorities or to a database maintained by one of the servers, generating a ticket for a traffic or parking violation, reporting about traffic or parking violations, and so forth.

Accordingly, the present technology allows individuals or public authorities to remotely scan and identify vehicles, verify their statuses, and facilitate processing of payments associated with fines, parking, the use of toll roads, and/or traffic or parking violations.

In one aspect of the present disclosure, a method for processing tollgate payments is provided. The method may comprise the step of acquiring, by a computing device having at least a processor and a memory storing processor-executable instructions, at least one identification signal emitted by an identification tag secured to a vehicle at the time of its passing through a tollgate, wherein the at least one identification signal conveys a vehicle identifier associated with the vehicle. The method further includes the step of maintaining, by the computing device and/or a server, a database of registered vehicles, wherein the database of registered vehicles comprises at least one record of vehicle information associated with the vehicle whose identification signal was acquired. The method further includes the step of making, by the computing device and/or the server, a charge transaction in accordance with one or more predetermined rules and against a vehicle owner's account. The method further includes the step of generating, by the computing device and/or the server, a billing record for a vehicle owner showing the charge transaction.

In certain embodiments, the method may further include the steps of determining, by the computing device, a status of the vehicle based at least in part on the identification signal and/or the vehicle identifier, wherein the status of the vehicle comprises information as to whether or not the vehicle is stolen, wanted, parked, travelling, unlisted (invalid ID), and pass (clear); and reporting, by the electronic device and based on the status, to one or more authorities the fact that the vehicle passed through the tollgate. In certain embodiments, the method may further include the step of updating, by the computing device, the database of registered vehicles by making a record indicating a date, time, and charge amount associated with the passing through the tollgate by the vehicle. In yet more embodiments, the method may further include the step of transmitting, by the computing device, a report to a user device of the vehicle owner, wherein the report comprises a date, time, and charge amount associated with the passing through the tollgate by the vehicle. In some embodiments, the identification signal may further comprise a plate number associated with the vehicle. The identification tag may include an active radio-frequency identification tag or an active/passive radio emitter. The identification tag may also be a part of vehicle license plate.

In another aspect of the present disclosure, a method for processing parking payments is provided. The method comprises the step of acquiring, by a parking meter, an identification signal emitted by an identification tag secured to a vehicle located in a predetermined proximity and direction from the parking meter, wherein the at least one identification signal conveys a vehicle identifier associated with the vehicle. The method further comprises the step of identifying, by the parking meter and/or a server, a vehicle owner and an account associated with the vehicle owner in a database of registered vehicles based at least in part on the identification signal and/or the vehicle identifier. The method further comprises the step of making, by the parking meter and/or the server, a charge transaction in accordance with one or more predetermined rules and against the account of the vehicle owner. The method further comprises the step of generating, by the parking meter and/or the server, a billing record for the vehicle owner showing the charge transaction.

In certain embodiments, the method may further include the steps of identifying, by the parking meter, when the identification signal is not emitted by the vehicle; and calculating, by the parking meter, a parking time period associated with a time period when the vehicle was parked in the predetermined proximity of the parking meter; and wherein the charge transaction depends on the parking time period. In certain embodiments, the method may further include the steps of determining, by the parking meter and/or the server, a status of the vehicle based at least in part on the identification signal and/or the vehicle identifier, wherein the status comprises information as to whether the vehicle is stolen, wanted, parked, on travel, unlisted (invalid ID), and pass (clear); and reporting, by the parking meter and/or the server, to one or more authorities, based on the determination, the fact that the vehicle is located near the parking meter. In certain embodiments, the method may further include the steps of updating, by the parking meter and/or the server, the database of registered vehicles by making a record indicating a date, time, and charge amount associated with the vehicle parked near the parking meter. In yet more embodiments, the method may further include the steps of determining, by the parking meter, that no identification signals are received from the predetermined proximity from the parking meter for a period of time greater than a predetermined value; based on the determination, updating, by the parking meter, a parking spot status associated with the parking meter, in a parking database maintained by the server, wherein the parking spot status indicates that a parking spot associated with the parking meter is available. In yet more embodiments, the method may further include the steps of receiving, by the server, a request from at least one electronic device to show at least one parking spot available; identifying, by the server, at least the parking spot status associated with the parking meter; and responsive to the request, transmitting, by the server, to the at least one electronic device parking spot information associated with the parking meter, the parking spot information comprising at least a location of the parking meter or parking spot associated with the parking meter.

In another aspect of the present disclosure, a method for processing parking payments is provided. The method comprises the step of acquiring, by a computing device having at least a processor and a memory storing processor-executable instructions, at least one identification signal emitted by an identification tag secured to a vehicle that is in a predetermined proximity from the computing device, wherein the at least one identification signal conveys a vehicle identifier associated with the vehicle. The method further comprises the step of identifying, by the computing device, that the vehicle is parked by determining that the vehicle is not moving for a time period greater than a predetermined value. The method further comprises the step of identifying, by the computing device, a status of the vehicle in a database of registered vehicles based at least in part on the identification signal and/or the vehicle identifier, wherein the database of registered vehicles is maintained by a server, and the status comprises information as to whether or not the parking was paid by a vehicle owner. The method further comprises the step of making, by the computing device and/or a server, a charge transaction associated with a fine for a parking violation in accordance with one or more predetermined rules and against an account of the vehicle owner based on the status of the vehicle. The method further comprises the step of generating, by the computing device and/or the server, a billing record for a vehicle owner showing the charge transaction.

In certain embodiments, the determining that the vehicle is not moving comprises determining, by the computing device, a distance between the computing device and the vehicle multiple times for a predetermined period of time. In certain embodiments, the method further comprises the steps of transmitting, by the computing device and/or the server, the billing record to a portable mobile device associated with the vehicle owner. In certain embodiments, the method further comprises the steps of determining, by the computing device and/or the server, a secondary status of the vehicle based at least in part on the identification signal and/or the vehicle identifier, wherein the secondary status comprises information as to whether the vehicle is stolen, wanted, on travel, unlisted (invalid ID),or pass (clear); and reporting, by the computing device and/or the server, to one or more authorities, based on the determination, the fact that the vehicle is located within a predetermined distance from the computing device. In certain embodiments, the computing device comprises one or more of the following: a portable electronic device, a personal digital assistant (PDA), a cellular phone, a portable laptop computer, and a tablet computer. In certain embodiments, the method further comprises the steps of providing a graphical user interface (GUI) displayable by the computing device and displaying a description of the vehicle.

In further example embodiments, steps of methods described herein may be stored on a computer readable storage medium having program instructions embodied thereon, with the program instructions executable by a processor in a computing device. In yet further exemplary embodiments, modules, subsystems, or devices can be adapted to perform the method steps. Other features and exemplary embodiments will be evident from the detailed description provided below.

### BRIEF DESCRIPTION OF DRAWINGS

Embodiments are illustrated by way of example and not limited in the figures of the accompanying drawings, in which like references indicate similar elements and in which:

FIG. 1 shows a high-level block diagram illustrating a system environment within which methods for vehicle identification may be implemented.

FIG. 2 is a diagrammatic representation of an example electronic device in the form of a computer system within which a set of instructions for the electronic device to perform any one or more of the methodologies discussed herein is executed.

FIG. 3 shows a high-level process flow diagram of a method for vehicle identification, according to methodologies discussed herein.

FIGS. 4-10 illustrate schematic diagrams of various GUIs displayable by an electronic device at different stages of vehicle status identification, according to embodiments of the present disclosure.

FIG. 11 shows an exemplary data structure of database of registered vehicles.

FIG. 12 shows a high-level process flow diagram of a method for processing tollgate payments.

FIG. 13 shows a high-level process flow diagram of a method for processing parking payments through a parking meter.

FIG. 14 shows a high-level process flow diagram of another method for processing parking payments using a portable electronic device.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors, controllers or other specially designed application-specific integrated circuits (ASICs), programmable logic devices, or various combinations thereof. In particular, the methods described herein may be implemented by a series of computer-executable instructions residing on a storage medium such as a disk drive, solid-state drive, or on a computer-readable medium.

In general, various embodiments of the present disclosure implement a technology for vehicle identification and, more specifically, identification of a vehicle status. The technology involves installation of identification tags on vehicles, which can actively or passively emit identification signals conveying vehicle identifiers and, optionally, other information. A member of the public or an interested party, such as a police officer or parking officer, can be equipped with an electronic device suitable for receiving identification signals from the device installed on the vehicle and process the signals in order to identify the vehicle's status. The vehicle status can be indicative of whether a particular vehicle is stolen, wanted, associated with specific criminal offences, or if a vehicle is parked, on travel, unlisted (i.e., a fake signal), pass, and so forth. The vehicle status can be obtained by querying remote databases maintained by at least one server. Once the vehicle status is determined, it can be displayed or presented to the member of the public or other interested parties in various ways (e.g., on a display or by an audio signal).

The present technology can also enable its users to make reports when, for example, the member of the public or another interested party finds a vehicle not emitting an identification signal. Lack of this signal may be interpreted as illegal removal of identification tags from a vehicle. The user can visually identify the non-emitting vehicle since the device displays a description of the nearby vehicles. The vehicle not emitting any signal is not on the list. Another way to identify a non-emitting vehicle is by counting vehicles either manually or with the help of specific hardware. To these ends, the electronic device may enable its user to generate and send an electronic message to the server or relevant authorities including an identification of the location where a suspicious vehicle is located, a photo of a vehicle, and other related information or commentaries.

Accordingly, provided all vehicles within a specific area, such as a nation, country, state, district, or otherwise enclosed area, such as a private land or premises, are equipped with the identification tags, the present technology allows efficient detection of vehicle statuses. It is a very convenient and straightforward technology for use by the general public, government officials, military and police officers, and other authorities. The vehicle status may not only include information indicative of a particular vehicle being stolen or wanted, but also indicate whether any fines or warrants are outstanding, whether the vehicle passed a required inspection, whether the vehicle is associated with any civil or criminal offences, and so forth. Users will have access to information according to their level of clearance.

It is also important that, in certain embodiments, vehicle owners can themselves set vehicle statuses in the database. For example, the vehicle owners may set the vehicle status to ‘parked’ when they park their vehicles. In other embodiments, the vehicle owners may set the vehicle status to ‘on travel’ to designate that their intention is to remove a stopped vehicle from a dedicated area within a short period of time. Accordingly, this technology makes it impossible to take advantage of stealing identification tags from parked vehicles and placing them on stolen vehicles. The present technology allows citizens to determine whether vehicles they own have any outstanding fines, the date of their next vehicle service, permits associated with the vehicle, such as tinted windows, and so forth.

Furthermore, some embodiments of the present technology allow spotting attempts to duplicate identification tags. This ‘Chinese wall’ option provides for interaction between a database of stolen vehicles and a database of vehicle information based upon analysis of vehicle location data and corresponding vehicle identifiers. More specifically, in an example embodiment, an individual may request information concerning a particular vehicle within a distance range using his electronic device. For these ends, the electronic device acquires a vehicle identifier associated with the vehicle of interest and sends a request to a remote server. This request includes the vehicle identifier and a current location of the electronic device. Another server, which maintains vehicle data, such as location obtained directly from the vehicle in question, compares location data obtained from two independent sources and makes a determination as to whether the identification tag pertaining to the vehicle in question is duplicated. This analysis may also compare a time and date when location information was obtained and, optionally, other related information.

Notably, the present technology can serve as an instrument for obtaining information in a way not infringing on citizens' privacy rights, constitutional rights, or any other applicable laws. In some embodiments, the technology provides various clearance levels for the users of the technology. Specifically, there may be provided one clearance level for the general public, another clearance level for security firms, yet another clearance level for police officers and government officials, and so forth. In one example embodiment, the technology may provide the general public with the lowest clearance level, which means they may not need to use credentials to access certain types of information from third parties, such as basic vehicle description and display of status. Accordingly, the general public may have some limitations as to what information can be delivered to them through the use of the present technology. On the other hand, a higher level of clearance may be given to police officers meaning they need to have credentials to access and run the methods and functionalities as described herein. In return, the police officers may have access to information without any limitations or with fewer limitations. In some embodiments, access to the methods and functionalities of the present technology may require prior user authentication and authorization, for example, based upon biometric information (e.g., fingerprints, retina or iris images, face images) or a two-step authorization technique.

One aspect of the present technology relates to the maintaining of ad hoc online services for storing vehicle related information. More specifically, there are provided one or more web servers, which have a first database of vehicle statuses and a second database of registered vehicles. The first database includes merely vehicle statuses (i.e., ‘stolen,’ wanted,’ ‘parked,’ etc.), while the second database includes vehicle registration data, vehicle description data, user comments associated with various vehicles, and so forth.

At least one of these databases is a “crowdsourcing” data collection meaning that the content stored in the database is solicited by contributions from a large group of people—online community or general public—rather than from traditional employees or suppliers. However, in some embodiments, the databases may relate to government databases or proprietary databases maintained by a limited number of people. In either case, the databases are tamper proof through the use of private and public keys, encryption, cryptography, challenge response mechanisms, and tracking of quota and asynchronous calls, among other mechanisms. Accordingly, the insertion of new vehicles into the databases is a safe process as long as the above security mechanisms are implemented.

Furthermore, some aspects of the instant technology provides for mechanisms for collecting payments for parking, the use of tollgates, and payments associated with fines and tickets for traffic or parking violations. For these ends, the database of registered vehicles maintains records and/or accounts for a plurality of vehicles, each having a unique identification tag. Each of the records/accounts can be associated with a particular vehicle owner and may maintain payment details such as credit card details, banking account details, and billing address, as well as other information such as the vehicle owner's personal information, mailing address, contact information, and so forth. In some embodiments, the vehicle owners may have access to the database of registered vehicles to allow them to create and/or edit corresponding accounts for each registered vehicle (for example, through a website or mobile application and based on a clearance level). Therefore, the present technology enables makingpayment transactions using the payment details stored in the database of registered vehicles and based on predetermined rules. In some embodiments, the payment transactions can be initiated automatically, for example, when a vehicle moves through a tollgate or when it is parked nearby a parking meter, where both of the tollgate and parking meter are equipped with an identification signal readers. In other embodiments, the payment transactions can be initiated manually, for example, by government officials, such as police officers or parking enforcement officers, when they notice a parking violation of a particular vehicle. The officer may merely utilize the electronic device (e.g., a tablet computer) enabled to receive and process identification signals as discussed above, and generate an ‘e-fine,’ or in other words, issue a ticket for a parking or traffic violation. In either case, the payment transactions can be processed automatically using the payment details and can be further reflected as billing records in the corresponding records/accounts in the database of registered vehicles. In some exemplary embodiments, once the payment transaction is completed for a particular vehicle, the vehicle owner can be notified about the transaction and its purpose by an e-mail, text message, voice message, push notification, or any other suitable communication to his personal computing device such as a cellular phone or computer.

In some embodiments, parking payments can be automated in two possible ways. First, a vehicle owner may utilize his electronic device and set the vehicle status to the ‘parked’ status as discussed above, when he parks his vehicle in a dedicated area. Based on the status, a particular location of the vehicle, time/date, and other predetermined rules, a server may automatically make payment transactions and generate billing records in the vehicle owner's account. In one example, the transaction can be performed once the vehicle owner sets the status from ‘parked’ to ‘on travel’ status. In this case, the server can calculate a time period when the vehicle was parked and charge the vehicle owner accordingly. In other embodiments, the payment transactions can be performed regularly, for example, every 15-minute time period, 30-minute time period, 60-minute time period, and so forth until the parking status is not switched to ‘on travel’ status. In case the parking is duly paid by the vehicle owner, the payment fact can be later determined, for example, by parking enforcement officials so that they do not issue a ticket. Otherwise, if parking enforcement officials notice a parking violation, and if they determine that the payment for the parking was not made or has expired, they can proceed with issuing a ticket or making an ‘e-fine’ as outlined herein.

Second, the parking payments can be automated when a parking meter is equipped with a reader of identification signals emitted by identification tags. In this example, once a vehicle parks near the parking meter, the parking meter acquires the vehicle's identification signal, identifies the vehicle, and makes a payment transaction for the parking based on predetermined rules involving such parameters as time/date, location, schedule of fees, vehicle status, and so forth. Again, the vehicle owner can be notified about the payment transaction by specific communications and/or by generation of billing records in his account. Furthermore, once the payment transaction is completed, the parking meter or server may automatically change the status of the vehicle, for example, from ‘on travel’ status to ‘parked’ status so as the general public or officials may know that a particular vehicle is parked lawfully and does not violate the laws by not paying a requisite fee.

Similar to the examples given above, the payments for the use of toll roads can be automated as well. For these ends, tollgates can be equipped with readers of identification signals emitted by identification tags, and also be connected to a server having access to the database of registered vehicles. Once a particular vehicle appears near such a tollgate, or moves through it, the tollgate can automatically identify the vehicle by reading its identification signal, determine its status, and make a payment transaction based on predetermined rules, which can include such parameters as time/date, location, schedule of fees, vehicle status, and so forth. Again, the vehicle owner is notified every time the payment transaction is completed by receiving a corresponding communication, such as in the form of a push notification, text message, or email, and/or by generation of a billing record.

Notably, the parking meters and tollgates equipped with readers of identification signals can be further utilized in acquiring, collecting, and/or processing traffic or parking information. For example, a parking meter may repeatedly identify if a corresponding parking spot is available or there is a vehicle parked. If the spot is available, this information can be collected on a server and vehicle owners may later get access to this information, for example, through their personal, portable electronic devices, such as cellular phones, smart phones, or navigation systems. In other words, the vehicle owners may search for available parking spots based on the information collected in the server. As for the tollgates, they can facilitate collecting information as to how busy toll roads are at the moment by identifying a number of vehicles entering a toll road per a period of time.

Another relevant feature for payment processing technology is the determination of vehicle statuses on a regular basis. As mentioned above, the vehicle status can be indicative of whether a particular vehicle is wanted or stolen. In this regard, the parking meters and tollgates may also perform a status check for every vehicle for which they can sense an identification signal. If it is determined that the status of a particular vehicle is ‘stolen’ or ‘wanted,’ an automatic report can be generated and sent to authorities indicating a time, a location, and vehicle information. This feature provides an efficient method for locating stolen and wanted vehicles, and it helps government officials to quickly locate such vehicles and prosecute thefts.

Thus, the present technology allows significantly decreasing vehicle theft rates and increasing the rates of stolen vehicle recovery. In addition, it provides an easy to use mobile application or specific hardware with limited clearance for the general public that attracts a great number of people to be a part of a nation-wide vehicle security system. Furthermore, the present technology allows easy processing of payments associated with parking, the use of toll roads, tickets for traffic or parking violations. Provided below is a detailed description of various embodiments with reference to accompanying drawings.

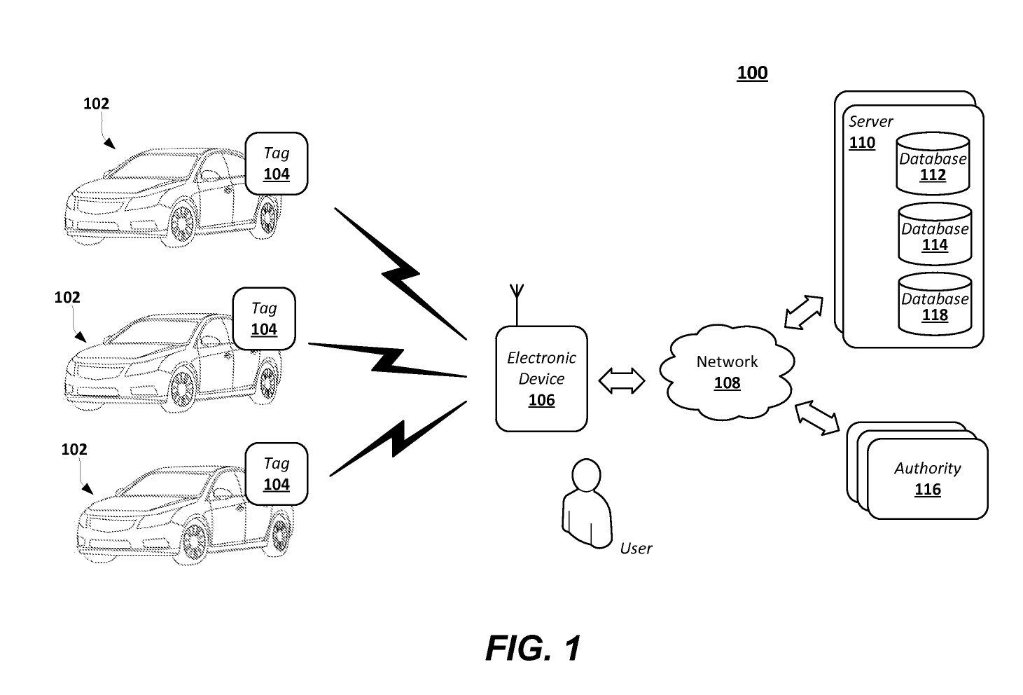

FIG. 1 shows a high-level block diagram illustrating a system environment 100 within which methods for vehicle identification and payment processing may be implemented, in accordance with an example embodiment. In particular, there are shown a number of motor vehicles 102, each of which is equipped with an identification tag 104. The terms “vehicle” or “motor vehicle,” as used herein, refer to any machine suitable for transferring passengers or cargo. This may include, without limitation, automobiles, cars, trucks, buses, motorcycles, bicycles, trains, ships, boats, watercrafts, and aircraft.

The identification tags 104 may include, for example, RFID tags, labels, or transponders, as well as wireless transmitters, portable communication devices, Wi-Fi emitter tags, Bluetooth emitter tags, and so forth. In case of RFID tags, the identification tags 104 may be of passive or active types. Passive identification tags 104 are powered by and read at short ranges via magnetic fields so that they emit electromagnetic waves conveying certain information. In other words, the passive identification tag 104, when powered, emits an identification signal. Active identification tags 104 are powered by a local power source, such as a battery, and repeatedly emit an identification signal. According to various embodiments, the identification signal includes at least a vehicle identifier (vehicle identifier refers, for example, to a unique alphanumeric code). In certain embodiments, the identification signal may also include other information such as a plate number and vehicle registration data, among other things. It should be also noted that the identification tags 104 emit identification signals with a limited short-range area. In some examples, the area of identification signal propagation is limited to 300 feet, although it is limited to 100 feet or even less in other example embodiments. The identification tags 104 are secured to the vehicles 102 in designated places. In one example, the tags 104 can be attached to or be an integral part of a license plate or a windshield sticker.

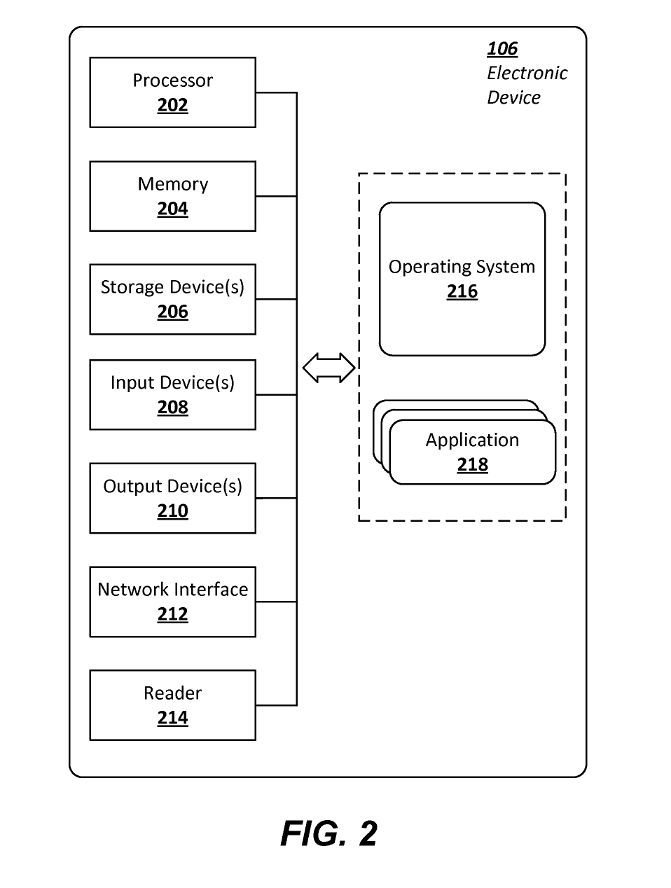

Still referencing to FIG. 1, there is provided an electronic device 106, which may refer, without limitation, to a portable computing device, tablet computer, laptop computer, general-purpose computer, netbook, mobile phone, smart phone, PDA, video recording system, and surveillance system, among others. The electronic device 106 is further described below and shown in FIG. 2. The electronic device 106 may be in possession of an individual, such as a police officer, although many other people may find it useful. In other embodiments, the electronic device 106 may be an integral part of a parking meter or a tollgate.

In general, the electronic device 106 is configured to wirelessly communicate with the identification tags 104. This may include powering and activating passive identification tags 104 by emitting electromagnetic waves and receiving responses from identification tags (i.e., identification signals). In other example embodiments, the electronic device 106 passively aggregates identification signals from active identification tags 104.

Upon receipt of the identification signals from the identification tags 104, the electronic device 106 processes them to retrieve vehicle identifiers associated with the vehicles 102. Further, the vehicle identifiers are used to obtain vehicle status data. In one example, the electronic device 106 inquires its own database of vehicle statuses (not shown) with the vehicle identifiers to determine if one of the vehicles 102 is stolen or wanted, or to retrieve vehicle registration data or related information. In another example, the electronic device 106 inquires, via a communication network 108, a server 110. The server 110 maintains a database, such as a database 112 of vehicle statuses, although the server 110 can maintain other databases including, but not limited to, a database 114 of registered vehicles containing vehicle registration data, state inspection data, information associated with outstanding fines or tickets, prior offences or traffic violation data, vehicle owner accounts, or a combination thereof. In some embodiments, the server 110 maintains a parking database 118 which includes a list of parking spot statuses. In some embodiments, the servers run crowdsourcing software to allow the general public to solicit content of the databases 112, 114, 118. In some other embodiments, the server 110 may include, be an integral part of, or in some other way be associated with the National Motor Vehicle Title Information System (NMVTIS), National Crime Information Center (NCIC), and Driver and Vehicle Licensing Agency (DVLA), among others.

In either case, the server 110 acquires the vehicle identification from the electronic device 106 and sends back a response conveying a partial record stored in the database 112 of vehicle statuses and optionally records from other databases such as the database 114. In a most simple case, the response contains a vehicle status like ‘Pass’ or ‘Fail,’ which may be coded in a single bit message element. In other words, the response includes information as to whether or not a particular vehicle 102 is listed in the database 112 of vehicle statuses. Thus, the electronic device 106 determines, based upon the server's response, the vehicle status and may display it on its screen, generate an alert audio or video message, generate a report, and the like. The user of the electronic device 106 may report the vehicle status to one or more of authorities 116 in certain cases, such as when a stolen vehicle is identified. Authorities 116 refers, without limitation, to a police department, Federal Bureau of Investigation (FBI), private security provider or firm, military, NMVTIS, NCIC, DVLA, or a combination thereof.

FIG. 2 is a high-level block diagram illustrating an example electronic device 106 suitable for implementing methods described herein. In particular, the electronic device 106 may be used for vehicle identification and identification of vehicle status. The electronic device 106 may include, be, or be an integral part of one or more of a variety of types of devices, such as a general-purpose computer, desktop computer, laptop computer, tablet computer, netbook, mobile phone, smartphone, PDA, vehicle computer, infotainment system, security device, and surveillance device, among others. Furthermore, the electronic device 106 may be an integrated part of another multi-component system such as a vehicle monitoring systems. In yet more embodiments, the electronic device 106 may be an integrated part of a parking meter or tollgate. Notably, FIG. 2 illustrates just one example of the electronic device 106 and in some embodiments the electronic device 106 may have fewer elements/modules than shown on FIG. 2 or more elements/modules than shown on FIG. 2.

As shown in FIG. 2, the electronic device 106 includes one or more processors 202, a memory 204, one or more storage devices 206, one or more input devices 208, one or more output devices 210, network interface 212, and a reader 214 (e.g., an antenna, interrogator, or reading device for RFID tags 104). One or more processors 202 are, in some examples, configured to implement functionality and/or process instructions for execution within the electronic device 106. For example, the processors 202 may process instructions stored in memory 204 and/or instructions stored on storage devices 206. Such instructions may include components of an operating system 216 or software application(s) 218. Electronic device 106 may also include one or more additional components not shown in FIG. 2, such as a housing, power supply, battery, global positioning system (GPS) receiver, payment module (e.g. credit card reader or coin slot), and so forth.

Memory 204, according to one example, is configured to store information within the electronic device 106 during operation. Memory 204, in some example embodiments, may refer to a non-transitory computer-readable storage medium or a computer-readable storage device. In some examples, memory 204 is a temporary memory, meaning that a primary purpose of memory 204 may not be long-term storage. Memory 204 may also refer to a volatile memory, meaning that memory 204 does not maintain stored contents when memory 204 is not receiving power. Examples of volatile memories include random access memories (RAM), dynamic random access memories (DRAM), static random access memories (SRAM), and other forms of volatile memories known in the art. In some examples, memory 204 is used to store program instructions for execution by the processors 202. Memory 204, in one example, is used by software (e.g., the operating system 216) or applications 218, such as a software application for vehicle identification or identification of vehicle status, executing on electronic device 106 to temporarily store information during program execution. One or more storage devices 206 can also include one or more transitory or non-transitory computer-readable storage media and/or computer-readable storage devices. In some embodiments, storage devices 206 may be configured to store greater amounts of information than memory 204. Storage devices 206 may further be configured for long-term storage of information. In some examples, the storage devices 206 include non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Still referencing to FIG. 2, the electronic device 106 may also include one or more input devices 208. The input devices 208 may be configured to receive input from a user through tactile, audio, video, or biometric channels. Examples of input devices 208 may include a keyboard, keypad, mouse, trackball, touchscreen, touchpad, microphone, one or more video cameras, image sensors, or any other device capable of detecting an input from a user or other source, and relaying the input to electronic device 106, or components thereof. Additional examples of input devices 208 include depth sensors, lidars, remote sensors, and so forth. Though shown separately in FIG. 2, the reader 214 may, in some instances, be a part of input devices 208. It should be also noted that the reader 214 may be a peripheral device operatively connected to the electronic device 106 via the network interface 212.

The output devices 210, in some examples, may be configured to provide output to a user through visual or auditory channels. Output devices 210 may include a video graphics adapter card, a liquid crystal display (LCD) monitor, a light emitting diode (LED) monitor, an organic LED monitor, a sound card, a speaker, a lighting device, a LED, a projector, or any other device capable of generating output that may be intelligible to a user. Output devices 210 may also include a touchscreen, presence-sensitive display, or other input/output capable displays known in the art.

The electronic device 106, in some example embodiments, also includes network interface 212. The network interface 212 can be utilized to communicate with external devices via one or more networks such as one or more wired, wireless, or optical networks including, for example, the Internet, intranet, local area network (LAN), wide area network (WAN), cellular phone networks (e.g. Global System for Mobile (GSM) communications network, packet switching communications network, circuit switching communications network), Bluetooth radio, and an IEEE 802.11-based radio frequency network, among others. The network interface 212 may be a network interface card, such as an Ethernet card, an optical transceiver, a radio frequency transceiver, or any other type of device that can send and receive information. Other examples of such network interfaces may include Bluetooth®, 3G, 4G, and WiFi® radios in mobile computing devices as well as USB.

The operating system 216 may control one or more functionalities of electronic device 106 and/or components thereof. For example, the operating system 216 may interact with the applications 218, including an application for vehicle identification or identification of vehicle status, and may facilitate one or more interactions between applications 218 and one or more of processors 202, memory 204, storage devices 206, input devices 208, and output devices 210. As shown in FIG. 2, the operating system 216 may interact with or be otherwise coupled to the application(s) 218 and components thereof. In some embodiments, application(s) 218 may be included in operating system 216. In these and other examples, virtual modules, firmware, or software for vehicle identification may be part of the applications 218. In other examples, virtual modules, firmware, or software for vehicle identification may be implemented externally to electronic device 106, such as at a network location. In some such instances, electronic device 106 may use the network interface 212 to access and implement functionalities provided by virtual modules, firmware, or software for vehicle identification through methods commonly known as “cloud computing.”

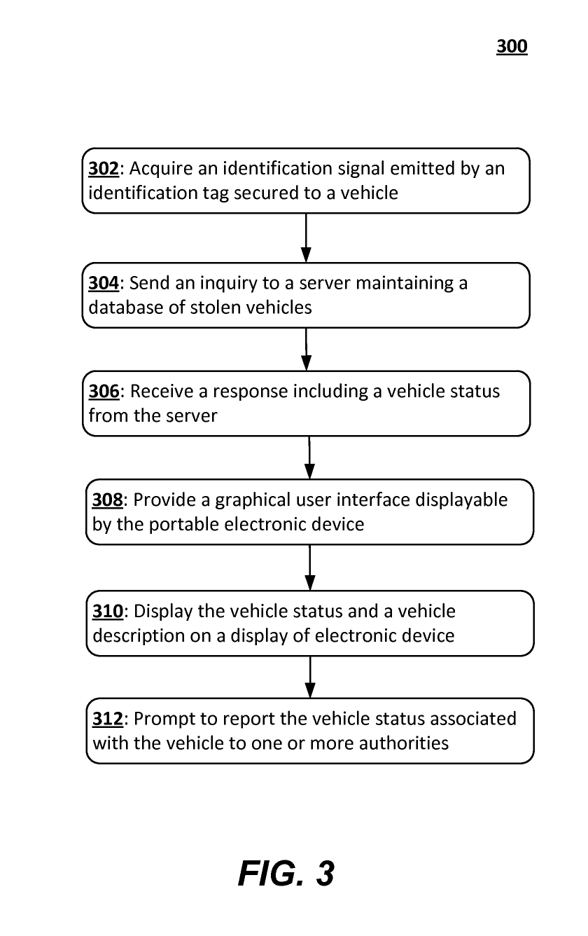

FIG. 3 shows a high-level process flow diagram of a method 300 for vehicle identification according to one exemplary embodiment. The method 300 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 300 is implemented by the electronic device 106 shown in FIGS. 1 and 2; however, it should be appreciated that the method 300 is just one example operation of the electronic device 106. In addition, the below recited steps of the method 300 may be implemented in an order different than described and shown in FIG. 3. Moreover, the method 300 may have additional steps not shown herein, but which can be evident for those skilled in the art from the present disclosure. The method 300 may also have fewer steps than outlined below and shown in FIG. 3.

The method 300 commences at step 302 with the electronic device 106 acquiring an identification signal emitted by an identification tag 104 secured to a motor vehicle 102. As described above, the identification signal conveys a vehicle identifier in the form of alphanumeric code or base 64 encoding. Optionally, the identification signal further includes additional information such as vehicle registration information, and/or plate number, among other things. At step 304, the electronic device 106 sends an inquiry to the server 110, which maintains a database such as the database 112 of vehicle statuses. The inquiry may simply contain the vehicle identifier retrieved from the identification signal and, optionally, other data. In some embodiments, the same or similar inquiry can be sent to the database 114 of registered vehicles to obtain additional information associated with the vehicle in question. At step 306, the electronic device 106 receives a response from the server 110 with a vehicle status from the database 112 with a basic description of the vehicle and optionally, according to clearance levels, additional data such as vehicle registration information, list of outstanding fines or tickets, list of offences associated with the vehicle 102 or a combination thereof, from the database 114. The vehicle status bears the information as to whether the vehicle 102 is stolen, wanted, suspicious, subject for inspection in view of other reasons, parked, and so forth. Thus, the electronic device 106 determines whether the vehicle 102 is listed in the database 112 of vehicle statuses. If the vehicle 102 is listed, then the electronic device 106 determines whether the status is pass or fail. If the vehicle 102 is not listed, the signal emitted is considered an altered signal and is reported as an invalid vehicle identifier (VID).

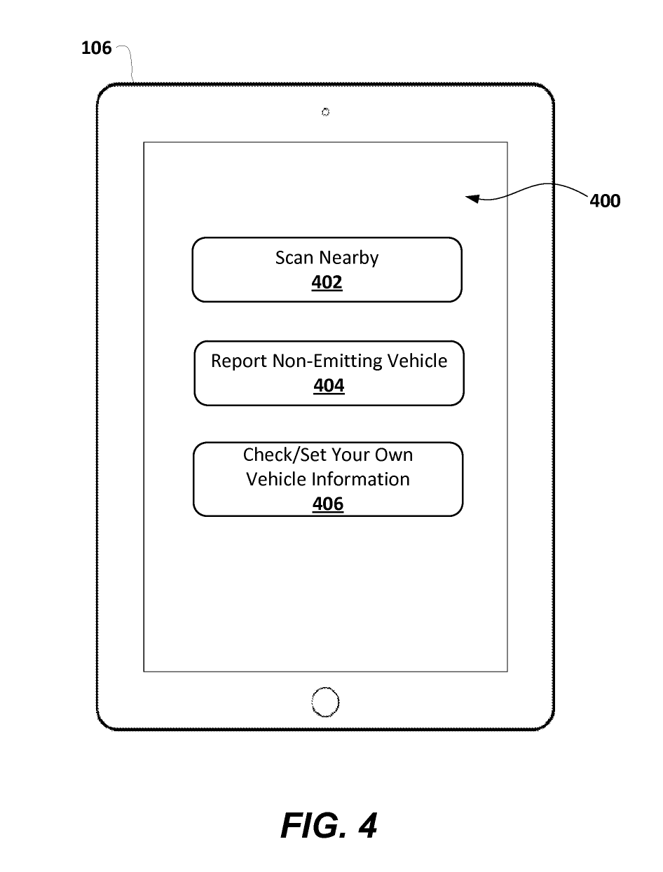

Further, at step 308, the electronic device 106 provides a GUI and displays it on a display of the electronic device 106. Exemplary GUIs are discussed below with reference to FIGS. 4-10. At step 310, the electronic device 106 displays, through the GUI, the vehicle status for attention of the user and optionally other information associated with the vehicle. At step 312, the electronic device 106 prompts the user to report the vehicle status to one of the authorities 116. The reporting includes sending an electronic message or alert via the network 108.

FIGS. 4-10 illustrate schematic diagrams of GUIs displayable by the electronic device 106 at different stages of vehicle status identification. As shown in these drawings, the electronic device 106 is a tablet computer; however, the same or similar GUIs may be provided for other types of electronic devices 106 such as desktop or laptop computers, cellular telephones, and so forth.

FIG. 4 shows a GUI 400 displayable at the time of activation of an application 218 for vehicle identification. In an example embodiment, the interface 400 includes actionable messages (buttons) or hyperlinks. Namely, these are ‘Scan Nearby’ button 402 and ‘Report Non-Emitting Vehicle’ button 404. When the user presses the button 402, the method 300 is activated and similarly, by pressing the button 404, at least some steps of a method for reporting non-emitting vehicles are implemented. ‘Check/Set Your Own Vehicle Information’ button 406 allows the user with login credentials to check and set information of vehicles the user owns.

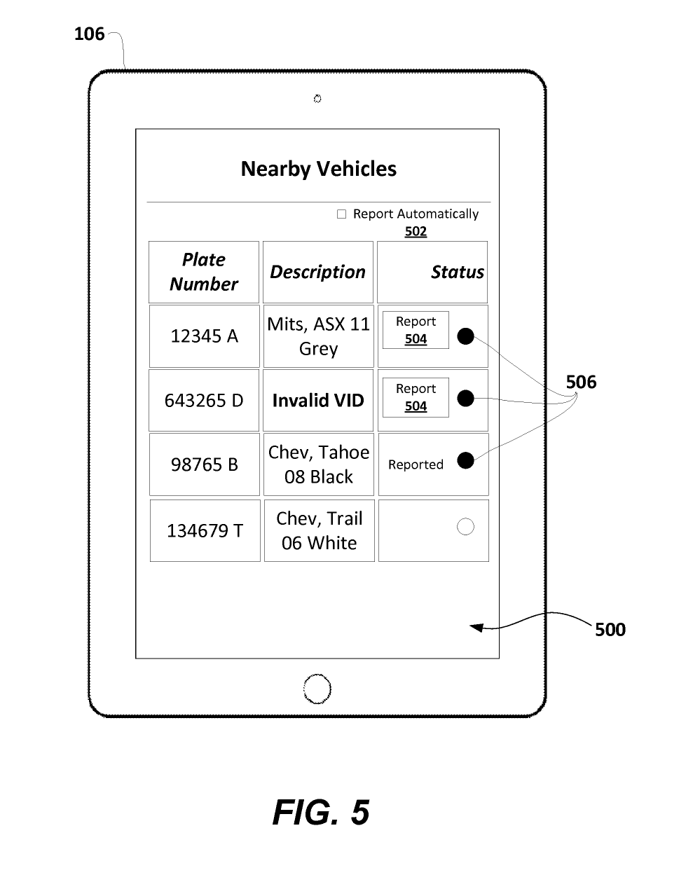

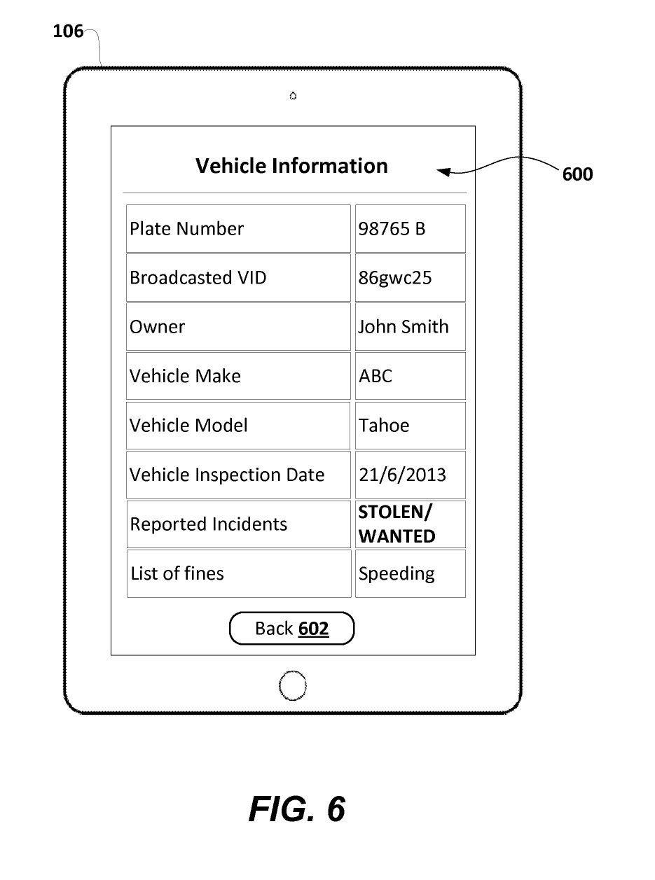

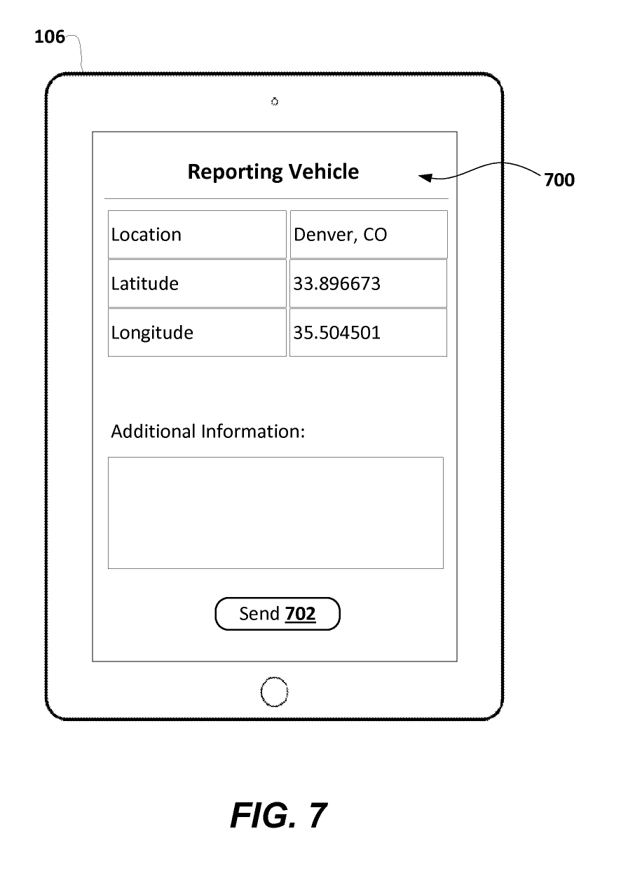

FIG. 5 shows a GUI 500 displayable in response to a press of the button 402. In particular, the GUI 500 shows the results of the method 300 for vehicle identification, which includes a tray (output box) where a table is presented. The table shows vehicle plate numbers of located vehicles, basic descriptions of vehicles, and vehicle statuses as acquired from the server. As shown in the figure, one of the table string lists ‘Invalid VID’ meaning that the vehicle with the plate number ‘643265 D’ is emitting a VID that is not listed in the database of vehicle statuses and thus requires special attention by competent authorities. One of the table strings lists a vehicle with a black dot 506 and plate number ‘12345 A’ meaning that the vehicle with plate number ‘12345 A’ is listed in the database with a Wanted/Stolen status reflected on the interface by the black dot 506. A ‘Report’ button 504 can be used by the user in order to report the vehicle on the same row of the table of the GUI 700 shown on FIG. 7. As shown on FIG. 5, the vehicle with plate number ‘98765 B’ with the black dot 506 has already been reported by the user of device 106. A ‘Report Automatically’ button 502 can be used by the user of device 106 to choose for the device 106 to report automatically about suspicious vehicles that are within the range area. Each string in the table may be actionable according to levels of clearance. For example, upon the user pressing on the line showing ‘987265 D’ as a plate number, the GUI is replaced with a GUI 600 shown in FIG. 6.

As illustrated in FIG. 6, the GUI 600 contains a table with detailed information regarding the selected vehicle 102. This GUI is reached only by users with proper clearance levels. The information may include, but is not limited to, vehicle registration data, plate number, owner's name, date of last state inspection, vehicle make, vehicle model, vehicle color, vehicle year, vehicle's representable image, list of reported incidents or accidents, list of offences associated with the vehicle or vehicle's owner, or a combination thereof. The GUI 600 also includes one actionable button: a ‘Back’ button 602 to return to the previous GUI 500.

FIG. 7 shows a GUI 700 displayable in response to the press of the button 504 shown on FIG. 5. FIG. 7 illustrates the GUI 700 suitable for reporting to one or more authorities 116. The GUI 700 includes a tray showing multiple fields with information subject for inclusion into a report. This may include, but is not limited to, location information, plate number, vehicle identifier, vehicle registration data, and additional information. Upon the user pressing a ‘Send’ button 702, the electronic device 106 transmits the report to one or more of the authorities 116.

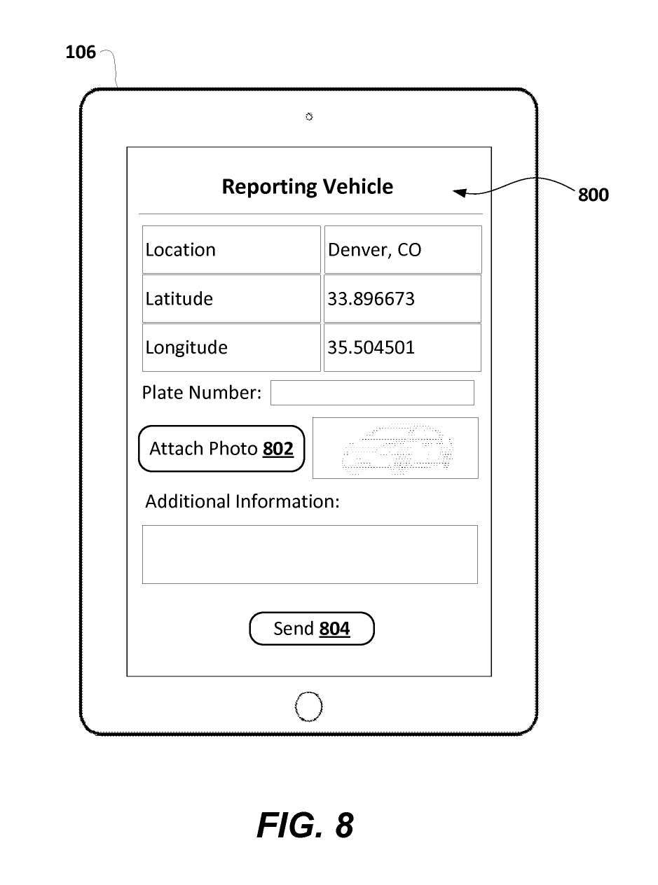

FIG. 8 shows a GUI 800 displayable in response to the press of the button 404. In particular, the GUI 800 relates to a method of reporting to the authorities 116 when a suspicious vehicle is identified by the user as not emitting any signal. Similar to FIG. 7, the GUI 800 shown in FIG. 8 has a tray for showing what information will be included or subject to inclusion in a report message. This includes, without limitation, location information, vehicle registration data (if available), plate number (which can be input by the user), a photo of the suspect vehicle (which can be added by the user when an “Attach Photo’ button 802 is activated), and additional information (as can be input by the user). Upon the user pressing a ‘Send’ button 804, the electronic device 106 transmits the report to the one or more of the authorities 116.

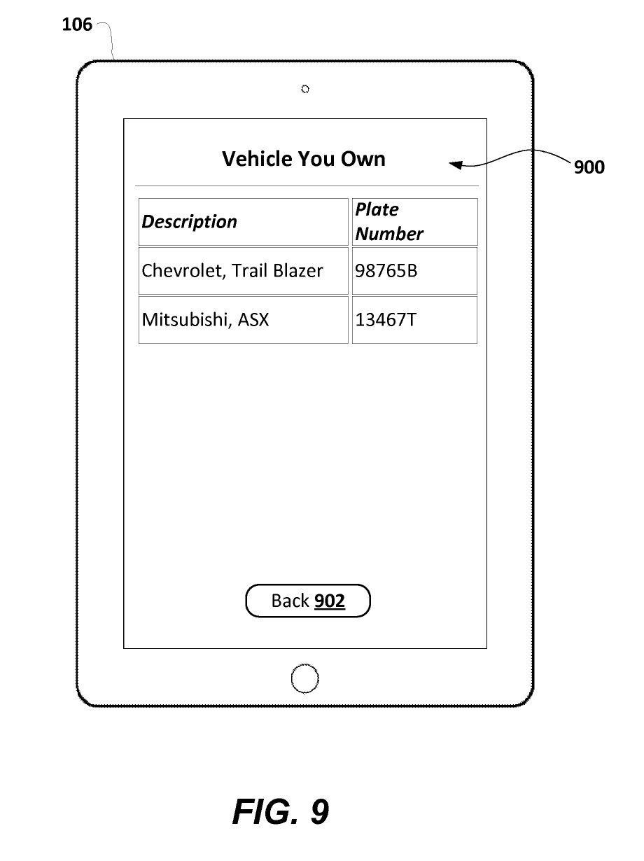

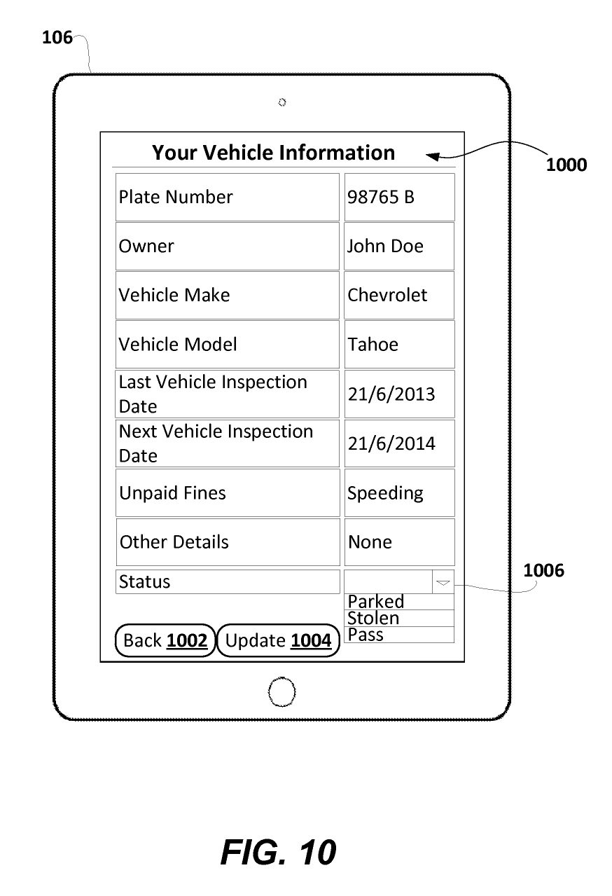

FIG. 9 shows a GUI 900 displayable in response to the press of the button 406 shown on FIG. 4. The GUI 900 displays a list of vehicles owned by the user currently logged into the system with specific secure credentials. The GUI 900 displays a table of strings with basic vehicle description and plate numbers. The GUI 900 also includes one actionable button: a ‘Back’ button 902 to return to the previous GUI 400. Each string in the table may be actionable. For example, upon the user pressing on the line showing ‘98765B’ as a plate number, the GUI 900 is replaced with a GUI 1000 shown on FIG. 10.

FIG. 10 shows a GUI 1000 displaying the user information about a particular vehicle the user owns. Information includes unpaid fines, last vehicle inspection date, next vehicle inspection date, and so forth. The GUI 1000 also includes an actionable button or drop down button 1006 for the user to set the status of the user own vehicle, such as parked, stolen, pass, and the like. Note that when user changes his vehicle status, a request is routed to authorities and after proper approval, the status of the vehicle will be effective. The GUI 1000 also includes an actionable ‘Update’ button 1004 that the user needs to press in order to update, in the database, the new status of the user vehicle chosen by activation of button 1006. The GUI 1000 also includes an actionable ‘Back’ button 1002 to go to the previous GUI 900.

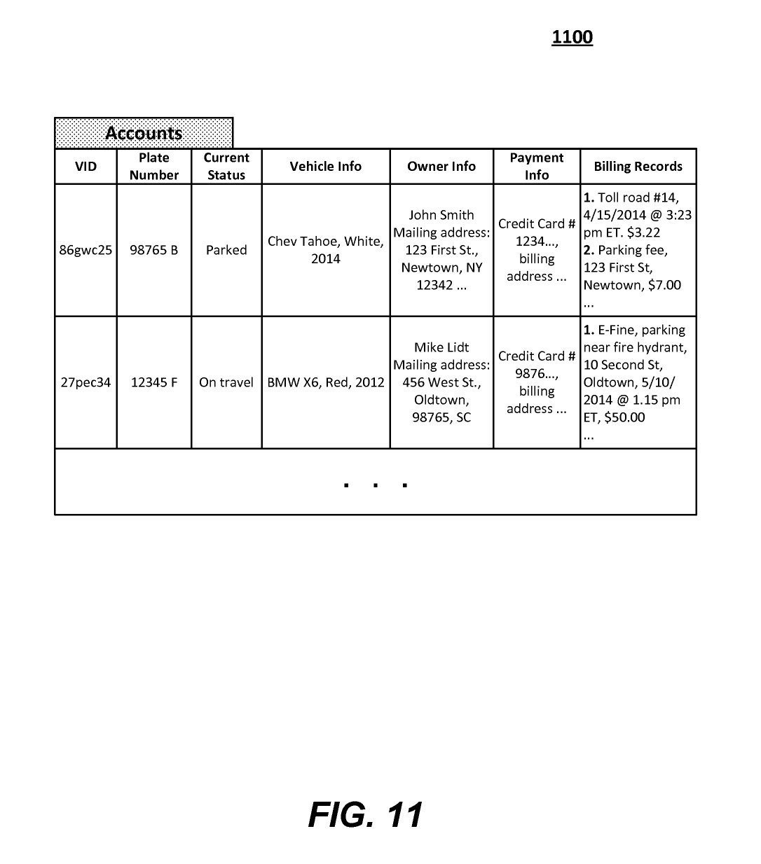

As discussed above, the database 114 of registered vehicles may maintain multiple accounts, with each associated with a particular vehicle. Each account may include records of a vehicle identifier, a vehicle plate number, vehicle information, vehicle owner information (e.g., name, mailing address, contact data), current vehicle status, payment information (e.g., credit card details, billing address), and billing records associated with prior charges for parking, parking or traffic violations, and/or the use of toll roads. FIG. 11 shows an exemplary data structure 1100 of database 114 of registered vehicles. The database 114 can be maintained by a server such as a server 110 so that multiple electronic devices 106 may have access to it when needed. Notably, vehicle owners may edit some or all information provided in their corresponding accounts. For example, the owners may edit their personal information, payment information, contact information, and so forth.

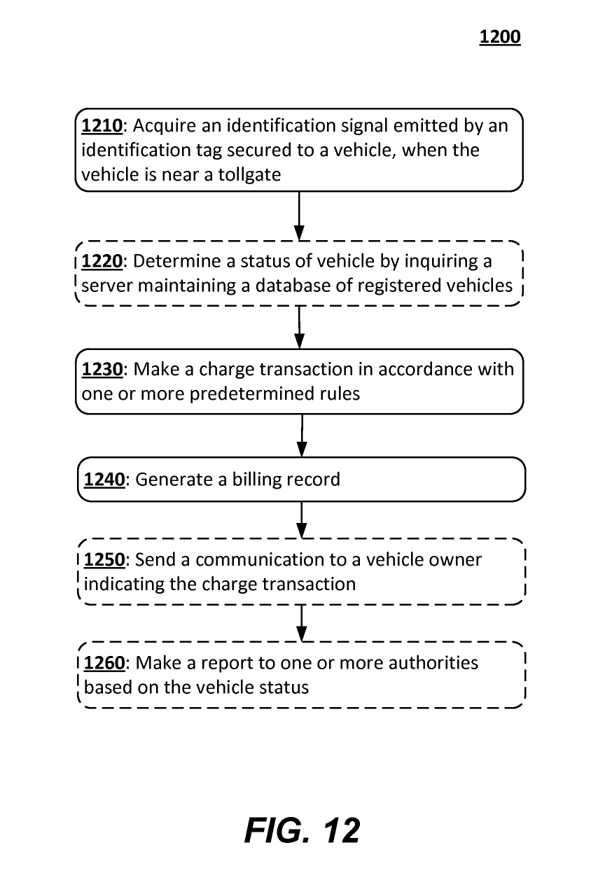

FIG. 12 shows a high-level process flow diagram of a method 1200 for processing tollgate payments, according to one exemplary embodiment. The method 1200 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 1200 is implemented by the electronic device 106 shown in FIGS. 1 and 2; however, it should be appreciated that the method 1200 is just one example operation of the electronic device 106. In this example, the electronic device 106 has the form of a tollgate or associated device. Importantly, the below recited steps of the method 1200 may be implemented in an order different than described and shown in FIG. 12. Moreover, the method 1200 may have additional steps not shown herein, but which can be evident for those skilled in the art from the present disclosure. The method 1200 may also have fewer steps than outlined below and shown in FIG. 12.

The method 1200 commences at step 1210 with the electronic device 106 (i.e. tollgate) acquiring an identification signal emitted by an identification tag 104 secured to a motor vehicle 102 at the time when the vehicle 102 is located within a predetermined distance from the electronic device 106 such as when the vehicle 102 passes through the electronic device 106. As described above, the identification signal conveys a vehicle identifier in the form of alphanumeric code or base 64 code. Optionally, the identification signal further includes additional information such as vehicle registration information and/or plate number, among other things.

At step 1220, the electronic device 106 optionally determines a status of the vehicle 102. For these ends, the electronic device 106 sends an inquiry to the server 110, which maintains the databases such as the database 112 of vehicle statuses and database 114 of registered vehicles. The inquiry may simply contain the vehicle identifier retrieved from the identification signal and optionally other data. In response to the inquiry, the electronic device 106 receives a response form the server 110 with a vehicle status from the database 112 with a basic description of the vehicle and optionally, according to clearance levels, additional data such as vehicle registration information, list of outstanding fines or tickets, list of offenses associated with the vehicle 102, or a combination thereof, from the database 114. The vehicle status bears the information as to whether the vehicle 102 is stolen, wanted, suspicious, subject for inspection in view of other reasons, parked, and so forth. Thus, the electronic device 106 determines whether or not the vehicle 102 is listed in the database 112 of vehicle statuses.

At step 1230, the electronic device 106 and/or the server 110 makes a charge transaction in accordance with one or more predetermined rules and against a vehicle owner's account. The predetermined rules may be based on one or more of the following parameters: a schedule of fees, location, date, time, vehicle information, vehicle owner information, vehicle status, plate number, and so forth.

At step 1240, the electronic device 106 and/or the server 110 generates a billing record for a vehicle owner showing the charge transaction. The billing record can be stored or associated with the vehicle owner account. For example, the billing record can be stored in the database 214 of registered vehicles and, therefore, the database 214 of registered vehicles is updated every time the charge transaction is complete. The billing record may include time and date of when the vehicle 102 passed through the tollgate, an amount charged, reason for the charge, payment method, and so forth.

At step 1250, the electronic device 106 and/or the server 110 optionally sends a communication to the vehicle owner indicating the charge transaction. The message can be in the form of, but not limited to, a text message, audio message, video message, push notification, e-mail, or snail mail.

At step 1260, the electronic device 106 and/or the server 110 optionally makes a report to one or more authorities 116 indicating that the vehicle 102, whose status was identified as being ‘stolen’ or ‘wanted,’ has passed through or nearby the electronic device 106 (i.e., tollgate). In this case, the authorities 116 may initiate the search and chase of the vehicle 102 as it may be stolen or the driver may have an outstanding warrant.

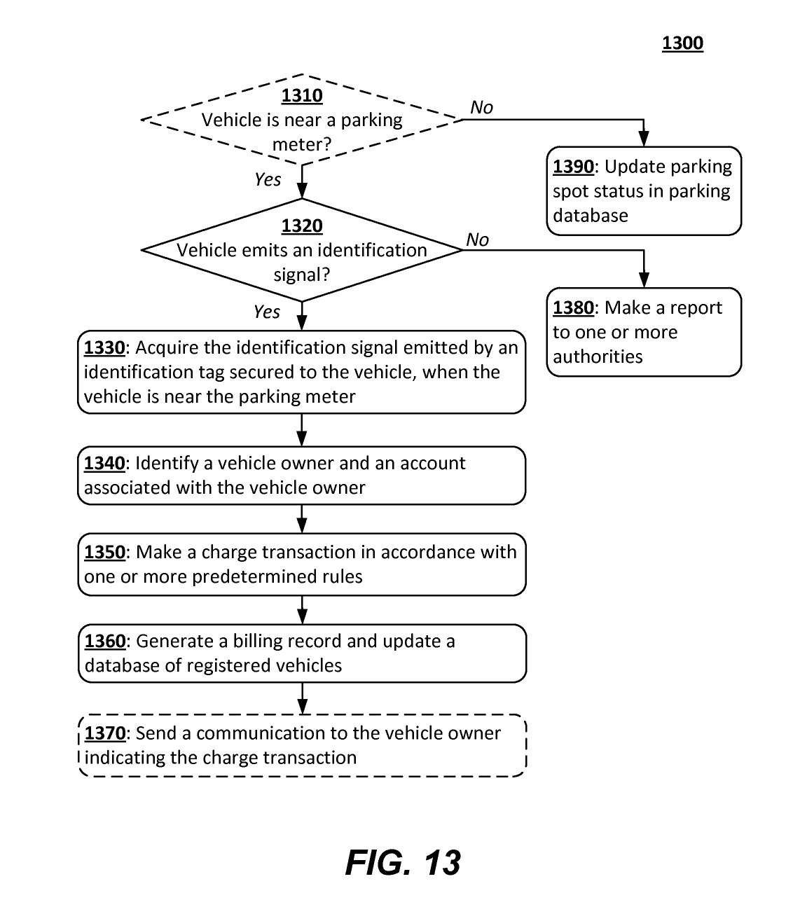

FIG. 13 shows a high-level process flow diagram of a method 1300 for processing parking payments through a parking meter according to one exemplary embodiment. The method 1300 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 1300 is implemented by the electronic device 106 shown in FIGS. 1 and 2; however, it should be appreciated that the method 1300 is just one example operation of the electronic device 106. In this example, the electronic device 106 has the form of a parking meter or the electronic device 106 is an integral part of a parking meter. Importantly, the below recited steps of the method 1300 may be implemented in an order different than described and shown in FIG. 13. Moreover, the method 1300 may have additional steps not shown herein, but which can be evident for those skilled in the art from the present disclosure. The method 1300 may also have fewer steps than outlined below and shown in FIG. 13.

The method 1300 commences at optional step 1310 with the electronic device 106 (i.e. parking meter) determining the presence of a motor vehicle 102 within a predetermined distance and/or direction from the electronic device 106. In other words, the electronic device 106 determines if the vehicle 102 is parked at a parking spot associated with the electronic device 106. For these ends, the electronic device 106 may embed proximity sensors, such as radio or infrared detectors configured to detect large-scale objects within a predetermined area. In other embodiments, the presence of the vehicle 102 is determined by receiving identification signals.

At step 1320, the electronic device 106 determines whether the motor vehicle 102 emits any identification signals. Notably, in some embodiments, the steps 1310 and 1320 may be combined into a single step. At step 1330, one or more identification signals emitted by an identification tag 104 secured to the motor vehicle 102 are acquired by the electronic device 106. Again, the identification signal may include a vehicle identifier and optionally additional information such as vehicle registration information, and/or plate number, among other things.

At step 1340, the electronic device 106 and/or the server 110 identify a vehicle owner and an account associated with the vehicle owner in the database 114 of registered vehicles based on the acquired identification signal or its part. For these ends, the electronic device 106 sends an inquiry to the server 110, which maintains the database 112 of vehicle statuses and database 114 of registered vehicles. The inquiry may contain the vehicle identifier retrieved from the identification signal and optionally other data. In response to the inquiry, the server 110 finds a corresponding record in the databases 112, 114, which record may have the form of vehicle owner account. The electronic device 106 and/or the server 110 may also optionally identify critical information such as the current status of vehicle 102 and, optionally, additional data such as vehicle registration information, list of outstanding fines or tickets, and so forth.

If the status of the vehicle is stolen or wanted, device 106 can automatically report the vehicle to the authorities along with the vehicle's position.

At step 1350, the electronic device 106 and/or the server 110 make a charge transaction for parking in accordance with one or more predetermined rules and against the vehicle owner's account. The predetermined rules can be based on one or more of the following parameters: a schedule of parking fees, location, date, time, vehicle information, vehicle owner information, vehicle status, plate number, and so forth.

At step 1360, the electronic device 106 and/or the server 110 generate a billing record for the vehicle owner showing the charge transaction. The billing record can be stored or associated with the vehicle owner account. For example, the billing record can be stored in the database 114 of registered vehicles and, therefore, the database 114 of registered vehicles is updated every time the charge transaction is complete. The billing record may include a time and date of when the vehicle 102 passed through the tollgate, an amount charged, reason for the charge, payment method, and so forth.

At step 1370, the electronic device 106 and/or the server 110 optionally sends a communication to the vehicle owner indicating the charge transaction. The message can be in the form of, but not limited to, a text message, audio message, video message, push notification, e-mail, or snail mail.

At step 1380, if no identification signals are acquired by the electronic device 106, but it is determined at the step 1310 that the vehicle 102 is parked, the electronic device 106 and/or the server 110 generate a report and send it to one of the authorities 116 to indicate that non-identifiable vehicle 102 is located near the electronic device 106. At this step, the electronic device 106 and/or the server 110 optionally makes also report to one of the authorities 116 if the vehicle status is identified as being ‘stolen’ or ‘wanted.’

Notably, if at the step 1310 it is determined by the electronic device 106 that no motor vehicles 102 are parked within a predetermined distance and/or direction from the electronic device 106 and that no identification signals are acquired for a period of time greater than a predetermined value, the electronic device 106, at step 1390, makes a determination that the corresponding parking spot near the electronic device 106 is available. Accordingly, the electronic device may optionally update a corresponding parking spot status in the parking database 118. The parking database 118 may maintain statuses of a plurality of parking meters, which statuses indicate whether a particular parking spot is available or not. The parking database 118 can be accessed by vehicle owners through a mobile device, navigation system, or computing device to facilitate the search of available parking spots. For example, a driver of a particular vehicle 102 initiates the search of nearby available parking spots through his mobile phone running a navigation mobile application. The application sends a corresponding request to the server 110 indicating the current location of the vehicle 102. In response to the request, the server 110 makes a search of one or more available parking spots currently available in the parking database 118 and returns to the mobile phone corresponding information of available parking spots and their locations. The user device displays the list of available parking spots and/or navigates the driver to at least one of the located available parking spots. Accordingly, this technology can be helpful in not only processing parking payments through parking meters in an automatic manner, but also in facilitating the search of available parking spots.

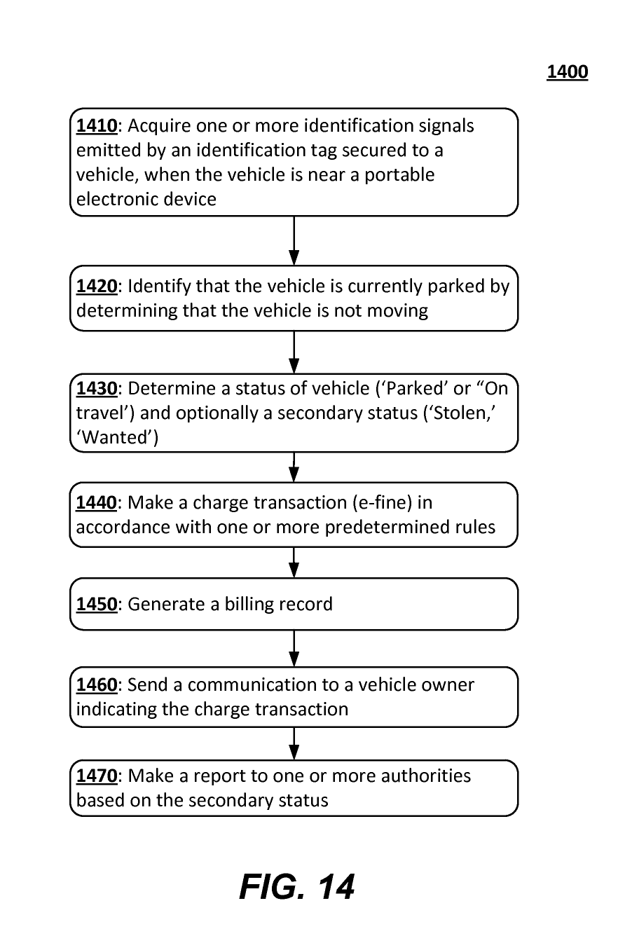

FIG. 14 shows a high-level process flow diagram of a method 1400 for processing parking payments through a portable electronic device 106 operated, for example, by a parking enforcement official or police officer. The method 1400 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 1400 is implemented by the electronic device 106 shown in FIGS. 1 and 2; however, it should be appreciated that the method 1400 is just one example operation of the electronic device 106. In this example, the electronic device 106 has the form of a tablet computer or wireless telephone with a touchscreen. Importantly, the below recited steps of the method 1400 may be implemented in an order different than described and shown in FIG. 14. Moreover, the method 1400 may have additional steps not shown herein, but which can be evident for those skilled in the art from the present disclosure. The method 1400 may also have fewer steps than outlined below and shown in FIG. 14.

The method 1400 commences at step 1410 with the electronic device 106 (i.e. portable tablet computer in hands of a parking enforcement officer) acquiring one or more identification signals emitted by an identification tag 104 secured to a motor vehicle 102 being within a predetermined proximity of the electronic device 106. As described above, the identification signal conveys a vehicle identifier and, optionally, additional information such as vehicle registration information and/or plate number, among other things.

At step 1420, the electronic device 106 automatically identifies that the motor vehicle 102 is currently parked by determining that the motor vehicle 102 is not moving for a time period greater than a predetermined time period. For these ends, the electronic device 106 can measure a distance between the electronic device 106 and the vehicle 102 multiple times for at least said time period. The distance can be measured by determining a time period between when a ping message is sent by the electronic device 106 to the identification tag 104 and receiving a response by the electronic device 106.

At step 1430, the electronic device 106 determines a status of the vehicle 102. For these ends, the electronic device 106 sends an inquiry to the server 110, which maintains the databases such as the database 112 of vehicle statuses and database 114 of registered vehicles. The inquiry may simply contain the vehicle identifier retrieved from the identification signal and, optionally, other data. In response to the inquiry, the electronic device 106 receives a response form the server 110 with a vehicle status from the database 112 or 114. The vehicle status may include merely information whether or not the parking has been paid by the owner of the parked vehicle 102. In other words, the vehicle status may be as simple as ‘paid’ or ‘unpaid.’ However, in some embodiments, the vehicle status may include a secondary status, which includes a basic description of the vehicle and, optionally, according to clearance levels, additional data such as vehicle registration information, list of outstanding fines or tickets, list of offenses associated with the vehicle 102 or a combination thereof, from the database 114. The secondary status may bear the information as to whether the vehicle 102 is stolen, wanted, suspicious, subject for inspection in view of other reasons, and so forth.

At step 1440, the electronic device 106 and/or the server 110 make a charge transaction, in accordance with one or more predetermined rules and against a vehicle owner's account, if it is determined that the vehicle status obtained at step 1430 shows that the parking was not paid. In other words, a e-fine is issued for parking violation. Similar to the above examples, the predetermined rules may be based on one or more of the following parameters: a schedule of fees, location, date, time, vehicle information, vehicle owner information, vehicle status, plate number, and so forth.

At step 1450, the electronic device 106 and/or the server 110 generates a billing record for a vehicle owner showing the e-fine (i.e., the charge transaction including its reasons). The billing record can be stored or associated with the vehicle owner account. For example, the billing record can be stored in the database 114 of registered vehicles and, therefore, the database 114 of registered vehicles is updated every time the charge transaction is complete. The billing record may include a time and date of when the vehicle 102 was identified as being illegally parked, an amount charged, reason for the charge, payment method, and so forth.

At step 1460, the electronic device 106 and/or the server 110 optionally send a communication to the vehicle owner indicating the charge transaction. The message can be in the form of, but not limited to, a text message, audio message, video message, push notification, e-mail, or snail mail.

At step 1470, the electronic device 106 and/or the server 110 optionally make a report to one or more authorities 116 indicating that the vehicle 104, whose secondary status was identified as being ‘stolen’ or ‘wanted,’ is located in a particular location.

Thus, systems and methods for vehicle identification and payment processing have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for processing tollgate payments, the method comprising:
acquiring, by a computing device having at least a processor and a memory storing processor-executable instructions, at least one identification signal emitted by an identification tag secured to a vehicle at the time of its passing through a tollgate, wherein the at least one identification signal conveys a vehicle identifier associated with the vehicle;
maintaining, by the computing device and/or a server, a database of registered vehicles, wherein the database of registered vehicles comprises at least one record of vehicle information associated with the vehicle whose identification signal was acquired;
making, by the computing device and/or the server, a charge transaction in accordance with one or more predetermined rules and against a vehicle owner's account;
generating, by the computing device and/or the server, a billing record for a vehicle owner showing the charge transaction.

2. The method of claim 1, further comprising:
determining, by the computing device, a status of the vehicle based at least in part on the identification signal and/or the vehicle identifier, wherein the status of the vehicle comprises information as to whether or not the vehicle is stolen, wanted, parked, on travel, unlisted (invalid ID), or pass (clear); and
reporting, by the electronic device and based on the status, to one or more authorities the fact that the vehicle passed through the tollgate.

3. The method of claim 1, further comprising updating, by the computing device, the database of registered vehicles by making a record indicating a date, time, and charge amount associated with the passing through the tollgate by the vehicle.

4. The method of claim 1, further comprising transmitting, by the computing device, a report to a user device of the vehicle owner, wherein the report comprises a date, time, and charge amount associated with the passing through the tollgate by the vehicle.

5. The method of claim 1, wherein the identification signal further comprises a plate number associated with the vehicle.

6. The method of claim 1, wherein the identification tag includes an active radio-frequency identification tag.

7. The method of claim 1, wherein the identification tag includes an active or passive radio emitter.

8. The method of claim 1, wherein the identification tag is a part of a vehicle license plate.

9. A method for processing parking payments, the method comprising:
acquiring, by a parking meter, an identification signal emitted by an identification tag secured to a vehicle located in a predetermined proximity and direction from the parking meter, wherein the at least one identification signal conveys a vehicle identifier associated with the vehicle;
identifying, by the parking meter and/or a server, a vehicle owner and an account associated with the vehicle owner in a database of registered vehicles based at least in part on the identification signal and/or the vehicle identifier;
making, by the parking meter and/or the server, a charge transaction in accordance with one or more predetermined rules and against the account of the vehicle owner; and
generating, by the parking meter and/or the server, a billing record for the vehicle owner showing the charge transaction.

10. The method of claim 9, further comprising:
identifying, by the parking meter, when the identification signal is not emitted by the vehicle; and
reporting, by the parking meter and/or the server, to one or more authorities, based on the identification, the fact that the vehicle is located near the parking meter.

11. The method of claim 9, further comprising:
determining, by the parking meter and/or the server, a status of the vehicle based at least in part on the identification signal and/or the vehicle identifier, wherein the status comprising information as to whether or not the vehicle is stolen, wanted, parked, on travel, unlisted (invalid ID), or pass (clear); and
reporting, by the parking meter and/or the server, to one or more authorities, based on the determination, the fact that the vehicle is located near the parking meter.

12. The method of claim 9, further comprising updating, by the parking meter and/or the server, the database of registered vehicles by making a record indicating a date, time, and charge amount associated with the vehicle parked near the parking meter.

13. The method of claim 9, further comprising:
determining, by the parking meter, that no identification signals are received from the predetermined proximity from the parking meter for a period of time greater than a predetermined value;
based on the determination, updating, by the parking meter, a parking spot status associated with the parking meter in a parking database maintained by the server, wherein the parking spot status indicates that a parking spot associated with the parking meter is available.

14. The method of claim 12, further comprising:
receiving, by the server, a request from at least one electronic device to show at least one parking spot available;
identifying, by the server, at least the parking spot status associated with the parking meter; and
responsive to the request, transmitting, by the server, to the at least one electronic device parking spot information associated with the parking meter, the parking spot information comprising at least the location of the parking meter or parking spot associated with the parking meter.

15. A method for processing parking payments, the method comprising:
acquiring, by a computing device having at least a processor and a memory storing processor-executable instructions, at least one identification signal emitted by an identification tag secured to a vehicle being in a predetermined proximity from the computing device, wherein the at least one identification signal conveys a vehicle identifier associated with the vehicle;
identifying, by the computing device, that the vehicle is parked by determining that the vehicle is not moving for a time period greater than a predetermined value;
identifying, by the computing device, a status of the vehicle in a database of registered vehicles based at least in part on the identification signal and/or the vehicle identifier, wherein the database of registered vehicles is maintained by a server, and the status comprises information as to whether or not the parking was paid by a vehicle owner;
making, by the computing device and/or a server, a charge transaction associated with a fine for a parking violation in accordance with one or more predetermined rules and against an account of the vehicle owner based on the status of the vehicle; and
generating, by the computing device and/or the server, a billing record for a vehicle owner showing the charge transaction.

16. The method of claim 15, wherein the determining that the vehicle is not moving comprises determining, by the computing device, a distance between the computing device and the vehicle multiple times for a predetermined period of time.

17. The method of claim 15, further comprising transmitting, by the computing device and/or the server, the billing record to a portable mobile device associated with the vehicle owner.

18. The method of claim 15, further comprising:
determining, by the computing device and/or the server, a secondary status of the vehicle based at least in part on the identification signal and/or the vehicle identifier, wherein the secondary status comprises information as to whether or not the vehicle is stolen, wanted, on travel, unlisted (invalid ID), or pass (clear); and
reporting, by the computing device and/or the server, to one or more authorities, based on the determination, the fact that the vehicle is located within a predetermined distance from the computing device.

19. The method of claim 15, wherein the computing device comprises one or more of the following: a portable electronic device, a personal digital assistant, a cellular phone, a portable laptop computer, and a tablet computer.

20. The method of claim 15, further comprising providing a graphical user interface displayable by the computing device and displaying a description of the vehicle.
